(19) United States
(12) Patent Application Publication
(10) Pub. No.: US 2024/0155040 A1
(43) Pub. Date: May 9, 2024

(54) Configuring Network Services To Support An Application

(71) Applicant: QUALCOMM Incorporated, San Diego, CA (US)

(72) Inventors: Thomas STOCKHAMMER, Bergen (DE); Imed BOUAZIZI, Frisco, TX (US); Alberto RICO ALVARINO, San Diego, CA (US); Haris ZISIMOPOULOS, London (GB)

(21) Appl. No.: 18/503,139

(22) Filed: Nov. 6, 2023

(30) Foreign Application Priority Data
Nov. 7, 2022 (GR) 20220100907

(51) Int. Cl. H04L 67/51; G06F 16/955; H04L 67/60

(52) U.S. Cl. CPC H04L 67/51; G06F 16/955; H04L 67/60

(57) ABSTRACT

Embodiments of systems and methods for configuring network services to support an application may include launching an application that will communicate with a network element to perform an application operation, sending a service request to a uniform resource locator (URL) associated with a data handling service that supports the application operation in response to launching the application, wherein the service request is configured to cause activation of the data handling service, and performing the application operation using communications received from the network element that are supported by the data handling service. In some embodiments the service request may be sent to the URL associated with the data handling service automatically in response to launching the application. The activation of the data handling service may occur in the UE, in a communication network, or both. The application may be a portal application. The network element may include a network service provider.

### RELATED APPLICATIONS

This application claims priority to Greek Patent Application No. 20220100907 entitled “Configuring Network Services To Support An Application” filed Nov. 7, 2023, the entire contents of which are incorporated herein by reference for all purposes.

### BACKGROUND

3rd Generation Partnership Project (3GPP) Long Term Evolution (LTE), Fifth Generation (5G) New Radio (NR), and other communication technologies enable improved communication and data services. Endpoint computing devices may utilize data handling and transport functions of a 3GPP communication network to send and receive a variety of information that enables the operation of applications and services on an endpoint device. To invoke and use such data handling and transport functions of a 3GPP communication network, the endpoint computing device and a network element must be instructed to perform operations to initiate or activate the data handling and transport functions of the network.

### SUMMARY

Various aspects include methods and user equipment (UE) configured to perform the methods of configuring network services to support an application. Various aspects may include launching an application that will communicate with a network element to perform an application operation, sending a service request to a uniform resource locator (URL) associated with a data handling service that support the application operation in response to launching the application, in which the service request is configured to cause activation of the data handling service, and performing the application operation using communications received from the network element that are supported by the data handling service. In some aspects, sending the service request to the URL associated with the data handling service that supports the application operation may include sending the service request to the URL automatically in response to launching the application.

Some aspects may include obtaining the URL from a communication network, in which the URL is associated with the data handling service and a data service provided by the network element. In some aspects, the activation of the data handling service may occur in the UE, in a communication network, or both. In some aspects, the application may be a portal application. In some aspects, the network element may include a network service provider.

In some aspects, automatically sending the service request to the URL associated with the data handling service that supports the application operation may include transmitting the service request to a URL of a network service handler function in a communication network, in which the service request is configured to be resolved by the network service handler function to initiate a network data handling service in the communication network.

Some aspects may include receiving a redirection message from the network service handler function in response to the service request, executing in the UE a media service application configured to receive the communications from the network element in response to the received redirection message, receiving by the media service application the communications from the network element that are supported by the network data handling service, and performing operations by the media service application using the received communications to support the application operation. In some aspects, automatically sending the service request to the URL associated with the data handling service that support the application operation may include resolving the URL associated with the data handling service using a UE service handler function executing in the processor of the UE, initiating in the UE a UE data handling service that supports the application operation, and executing in the UE a media service application configured to receive the communications from the network element that are supported by the UE data handling services.

In some aspects, performing the application operation using received communications that are supported by the data handling service may include receiving by the UE data handling service the communications from a network service provider, providing the received communications to the media service application, and performing operations by the media service application using the received communications to support the application operation. Some aspects may include activating the media application function by the UE service handler function.

In some aspects, automatically sending the service request to the network URL associated with the data handling service that supports the application operation may include resolving the URL associated with the data handling service using a UE service handler function executing in the processor of the UE, initiating in the UE a UE data handling service that supports the application operation, executing in the UE a media service application configured to receive the communications from the network element, transmitting a second service request to a network service handler function in a communication network, in which the second service request is configured for resolution by the network service handler function to initiate a network data handling service in the communication network, and receiving by the media service application the communications from the network element that are supported by the network data handling service and the UE data handling service. In such aspects, performing the application operation using the received communications that are supported by the data handling service may include performing operations by the media service application using the received communications from the network element that are supported by the network data handling service and the UE data handling service. Some aspects may include transmitting from the UE service handler function to a network service handler function a request for service parameters associated with the data handling service, receiving the service parameters from the network service handler function, and configuring the UE data handling service based on the received service parameters.

Further aspects include a UE having a processor configured to perform one or more operations of any of the methods summarized above. Further aspects include a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

Various aspects include methods and network elements configured to perform the methods of configuring network services to support an application. Various aspects may include receiving a service request directed at a URL associated with a data handling service that support an application operation of an application of a UE, resolving by a network service handler function the URL to the network data handling service, and activating the network data handling service in response to resolving the URL to the network data handling service. In some aspects, the application may be a portal application. In some aspects, the network element may be implemented as a part of a communication network. Some aspects may include transmitting a redirection message from the network service handler function to the UE in response to the service request, in which the redirection message is configured to trigger in the UE a media service application configured to support the application operation of the application of the UE.

Further aspects include a network element having a processor configured to perform one or more operations of any of the methods summarized above. Further aspects include a network element configured with processor-executable instructions to perform operations of any of the methods summarized above. Further aspects include a non-transitory processor-readable storage medium having stored thereon processor-executable instructions configured to cause a processor of a network element to perform operations of any of the methods summarized above. Further aspects include a network element having means for performing functions of any of the methods summarized above. Further aspects include a system on chip for use in a network element and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a component block diagram illustrating a system configured to perform operations for configuring network services to support an application according to various embodiments.

FIG. 4B is a message flow diagram illustrating a method for configuring network services to support an application according to various embodiments.

FIG. 4C is a component block diagram illustrating a system configured to perform operations for configuring network services to support an application according to various embodiments.

FIG. 4D is a message flow diagram illustrating a method for configuring network services to support an application according to various embodiments.

FIG. 4E is a component block diagram illustrating a system configured to perform operations for configuring network services to support an application according to various embodiments.

FIG. 4F is a message flow diagram illustrating a method for configuring network services to support an application according to various embodiments.

FIG. 5A is a process flow diagram illustrating a method performed by a processor of a UE for configuring network services to support an application according to various embodiments.

FIGS. 5B-5F are process flow diagrams illustrating operations that may be performed by a processor of a UE as part of the method for configuring network services to support an application according to various embodiments.

FIG. 6A is a process flow diagram illustrating a method performed by a processor of a network element for configuring network services to support an application according to various embodiments.

FIG. 6B is a process flow diagram illustrating operations that may be performed by a processor of a network element as part of the method for configuring network services to support an application according to various embodiments.

FIG. 7 is a component block diagram of a network element device suitable for use with various embodiments.

FIG. 8 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments may include user equipment (UE) and network elements (network computing devices) that are configured to perform operations for configuring network services to support an application executing on the UE. Various embodiments improve the operation of UEs and network elements by increasing the efficiency with which UEs and network elements may initiate or activate data handling and transport functions of a 3GPP communication network.

The term “computing device” is used herein to refer to any one or all of cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “network element” is used herein to refer to any one or all of a computing device that is part of or in communication with a communication network, such as a server, a router, a gateway, a hub device, a switch device, a bridge device, a repeater device, or another electronic device that includes a memory, communication components, and a programmable processor. A wireless device in communication with a network may be considered a network element of such network.

As used herein, the terms “network,” “communication network,” and “system” may interchangeably refer to a portion or all of a communications network or internetwork. A network may include a plurality of network elements. A network may include a wireless network, and/or may support one or more functions or services of a wireless network.

As used herein, “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

Endpoint computing devices may send and receive a variety of information that enables the operation of applications and services on an endpoint device. The transport of such information may utilize certain data handling and transport functions of a 3GPP communication network (referred to herein as a “data handling service”). Examples of data handling services include Dynamic Adaptive Streaming over Hypertext Transfer Protocol (DASH) and Hypertext Transfer Protocol Live Streaming (HLS). DASH or HLS may use or be used with, for example, Multimedia Broadcast Multicast Services (MBMS) user services, 5G broadcast services (e.g., MBMS Receive-Only Mode (MBMS ROM)), Multicast Broadcast Service (MBS) user services, and/or 5G media streaming functionalities. Another example of a data handling service includes an Extended Reality (XR) service using 5G Edge network Enablers (including Edge computing devices). In various embodiments, XR may include or refer to a variety of services, including virtual reality (VR), augmented reality (AR), mixed reality (MR), and other similar services. In various embodiments, data handling services may be enabled and/or provided by various functions instantiated in a communication network, such as a Broadcast-Multicast Service Center (BMSC), a Multicast-Broadcast Service Function (MBSF), a Multicast-Broadcast Service Transport Function (MBSTF), a 5G Media Streaming Application Function (5GMS AF), a 5G Broadcast Receiver function (e.g., which may be instantiated in a UE), an Edge Application Server, and Edge-enabling client (e.g., which may be instantiated in a UE), and/or other suitable data handling functions. To invoke and use such data handling and transport functions of a 3GPP communication network, the endpoint computing device and a network element must be instructed to perform operations to initiate or activate the data handling and transport functions of the network.

Various embodiments may include methods, and UEs and network elements configured to perform operations of the methods, for configuring network services to support an application that uses information received from a network element of a communication network, such as an application server that is part of a communication network or an application provider that is in communication with a communication network. In some embodiments, the UE and/or a network element may be configured to receive a service request message directed to a specifically configured uniform resource locator (URL) that is associated with a data handling service. A function instantiated in the UE and/or the network element may be configured to receive the service request message directed to the URL, and based on information in the service request message, the UE and/or the network element may perform operations to configure network services to support the application (e.g., to support communications for the application). In some embodiments, the URL may include a Hypertext Transfer Protocol (HTTP) or Hypertext Transfer Protocol Secure (HTTPS) URL as an entry point to which the service request message may be directed. The operations performed by the UE and/or the network element may activate (initiate, bootstrap) the data handling service (or data handling services) including functions of the 3GPP communication network to support the communications for the application.

In various embodiments, a handler function or resolver function may be instantiated in the UE and/or the communication network. The handler function or resolver function may be configured to receive the service request message directed to the URL and resolve the URL to a function that is configured to perform operations to activate (initiate, bootstrap) a data handling service (or data handling services) for the application. In some embodiments, the service request message may include information that specifies the requested data handling service(s). In some embodiments, the service request message also may include information for configuring one or more aspects of the data handling service(s). In some embodiments, aspects of the data handling service(s) may be activated in a network computing device of the communication network. For example, the data handling service may perform operations to allocate communication resources, set up transport resources, and transport MBMS information (e.g., packets). As another example, the data handling service may perform operations to allocate communication resources, set up transport resources, and transport 5G media streaming packets (e.g., via a Media Session Handling Application Function (MSH AF) and other suitable network functions). In some embodiments, aspects of the data handling service(s) may be activated in the UE. For example, aspects of an MBMS ROM service may be activated in the UE to enable reception and/or processing of multicast/broadcast information. In various embodiments, the URL may be defined to enable execution of data handling service bootstrapping, such as activating a preconfigured device function of a network element and/or a UE, or to support launching one or more device functions of a network element and/or a UE.

In various embodiments, a UE may be configured to launch an application that will communicate with a network element to perform an application operation, such as a portal application of the UE that communicates with the network element to obtain various data services such as media content, among other examples. The UE may send a service request to a URL associated with a data handling service that support the application operation in response to launching the application. In some embodiments, the UE may send the service request to the URL in response to launching the application automatically, i.e., without a further user input. Sending the service request automatically may improve the user experience by reducing the number of user inputs required to launch an application and enabling applications to begin receiving data services promptly after a single user action launching the application. The service request may be configured to cause activation of the data handling service, for example, in the UE and/or in a network element of a communication network. The UE may perform the application operation using communications received from the network element that are supported by the data handling service.

In some embodiments, the URL may be configured to be resolved by a function of a network element of the communication network. The URL may be resolved to a network function that activates the data handling service(s). In some embodiments, a network element may send a message to a media service application executing on the UE that includes a media entry point URL. The media entry point URL may enable the media service application executing on the UE to request content from a media service provider network element (e.g., via the communication network).

In some embodiments, sending the service request to the URL associated with the data handling service that supports the application operation may include transmitting the service request to a URL of a network service handler function in a communication network. In such embodiments, the service request may be configured to be resolved by the network service handler function to initiate a network data handling service in the communication network. In some embodiments, the media service application in the UE may receive a redirection message from the network service handler function in response to the service request. In some embodiments, the UE may execute the media service application configured to receive the communications from the network element in response to the received redirection message. The UE may receive, by the media service application, the communications from the network element that are supported by the network data handling service. The UE may perform operations by the media service application using the received communications to support the application operation.

In some embodiments, the URL may be configured for resolution by a UE service handler function executing in the UE. In some embodiments, the URL may be configured to include an indication of one or more data handling services, parameters of the data handling service, and a media entry point URL. In such embodiments, the UE may be configured with a service handler function. The UE service handler function may receive the service request that is directed to the URL. The UE service handler function may initiate a data handling service on the UE, and also may activate (initiate, launch, execute) a media service application on the UE. The UE media service application may receive communications from the network element, and may perform operations using the received communication to support the application operation.

In some embodiments, sending the service request to the URL associated with a data handling service that support the application operation may include resolving the URL associated with the data handling service using a UE service handler function executing in the processor of the UE, initiating in the UE a UE data handling service that supports the application operation, and executing in the UE a media service application configured to receive the communications from the network element that are supported by the UE data handling services, all of which may be performed automatically, i.e., without further user input. In some embodiments, the UE service handler function may activate the UE media application function. In some embodiments, the UE may perform the application operation by receiving by the UE data handling service the communications from the network service provider, providing the received communications to the media service application, and performing operations by the media service application using the received communications to support the application operation.

In some embodiments, the URL may be configured for resolution by a UE service handler function executing in the UE, and by a network service handler function in the communication network. In such embodiments, a UE function and a network function may be configured to receive the service request directed to the URL. For example, a UE service handler function executing in the processor of the UE may resolve the URL associated with the data handling services, and the UE may initiate a UE data handling service that supports the application operation. The UE also may execute a media service application in the UE that is configured to receive communications from a network element (e.g., a media service provider). The UE may transmit a second service request to a network service handler function in a communication network. The second service request may be configured for resolution by the network service handler function to initiate a network data handling service in the communication network.

In some embodiments, the UE media service application may receive the communications from the network element that are supported by the network data handling service and the UE data handling service. The UE media service application may perform operations (e.g., to support the application) using the received communications from the network element that are supported by the network data handling service and the UE data handling service. In some embodiments, the UE may launch an application of the media service provider using the media entry point URL (e.g., that may be included in the service request).

In some embodiments, the UE service handler function may request from and/or receive from the network service handler function service parameters associated with the data handling service(s). The UE service handler function may receive service parameter from the network service handler function. The US service handler function may configure the UE data handling service based on the received service parameters.

Various embodiments may include a network element including a processor configured to perform operations to configure network services to support an application. In some embodiments, the network element may receive a service request directed at a URL associated with a data handling service that support an application operation of an application of a UE. A network service handler function may resolve the URL to the network data handling service. The network element may perform operations to activate the network data handling service in response to resolving the URL to the network data handling service. In some embodiments, the network element may transmit a redirection message from the network service handler function to the UE in response to the service request. In such embodiments, the redirection message may be configured to trigger in the UE a media service application configured to support the application operation of the application of the UE.

In some embodiments, the UE may obtain (e.g., receive, request, be provided, etc.) an HTTP URL that is configured so as to be associated with a data service and a network data handling service. The UE may issue (e.g., transmit or transmit a message including) a request (e.g., a service request) to the URL on the UE. In response to the request issued by the UE, a data handling service may be launched in the UE (e.g., by or in a UE data handling service), or in a network element of the communication network (a network data handling service), or in both the UE and in the network element. In some embodiments, the UE also may automatically launch (e.g., execute, initiate, start, etc.) an application configured to handle communications of the data service received from and/or transmitted to the communication network, in which such communications are supported by the data handling service of the UE and/or the network.

In embodiments in which the data handling services launched in the network element (i.e., a network data handling service), in response to issuing the request to the URL, the UE may communicate with a network service handler in the communication network. The network service handler function may provide supporting functions for the associated data service. The network service handler function may send a message to the UE including a redirection message to the data service URL. In response to the redirection message and/or using the data service URL and/or other information in the redirection message, the UE may initiate (e.g., launch, start, etc.) a second application that may use (e.g., consume, utilize, perform operations using, etc.) communications (e.g., of information or data) of the associated data service. In some embodiments, the UE may receive the redirect message in response to the request transmitted to the URL. In some embodiments, the UE may execute a media service application that is configured to receive the communications from the network element in response to the received redirection message. The media service application may receive the communications from the network element that are supported by the (one or more) network data handling services. The media service application may perform operations to support the application operation using the received communications.

In embodiments in which the data handling service is launched in the UE, in response to the UE issuing the request to the URL, the UE may send a message (e.g., an instruction, command, etc.) to a function or module of the UE to launch a data handling service in the UE (i.e., a UE data handling service). The UE data handling service may receive (e.g., obtain, request and receive, collect, etc.) service accessed parameter(s) and/or media entry point(s) related to an application and/or application operation of the application executing in the UE. The UE data handling service may execute (e.g., initiate, start, launch, etc.) a second application that may receive communications from a network element via the UE data handling service. In some embodiments, a UE service handler function executing in the UE may resolve the URL associated with the network services. The UE may initiate one or more UE data handling services that support the application operation. The UE may execute a media service application that is configured to receive communications from the network element, which communications are supported by the UE data handling service.

In embodiments in which a data handling service is launched in both the UE and a network element of the communication network, in response to the UE issuing the request to the URL, the UE may send a message (e.g., an instruction, command, etc.) to a function or module of the UE to launch a data handling service in the UE (i.e., a UE data handling service). Additionally, the UE service handler function may communicate with a network service handler function to obtain (e.g., receive, collect, etc.) additional data (information, parameters, configuration information) from the network service handler function. In such embodiments, the UE may initiate a UE data handling service based on (e.g., using, in response to, etc.) the obtained information. The UE service handler function may launch a second application that is configured to consume information of or from the data service, to perform operations to support the application operation.

Various embodiments improve the operation of UEs and network elements by increasing the efficiency by which UEs and network elements may initiate or activate data handling and transport functions of a 3GPP communication network. Various embodiments simplify the operation of UEs and network elements by simplifying the activation of data handling services to support an application operation.

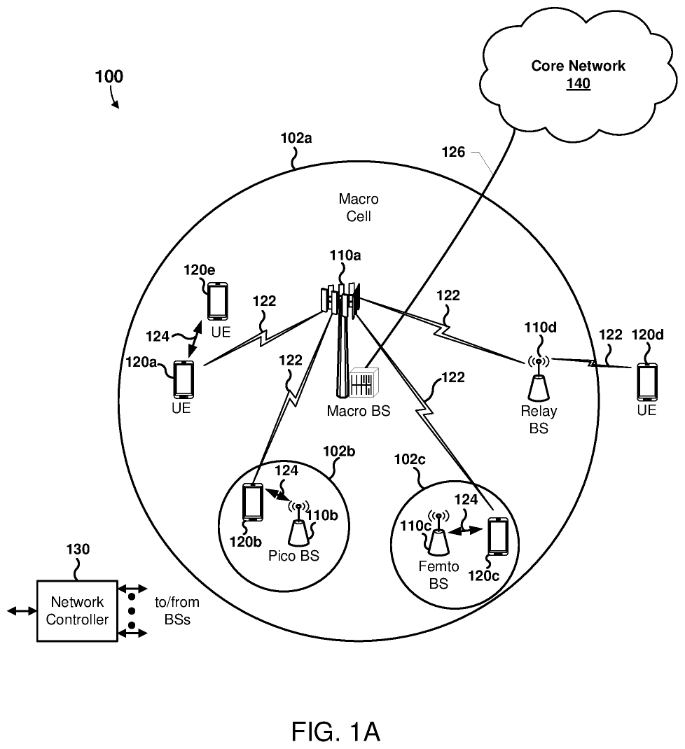

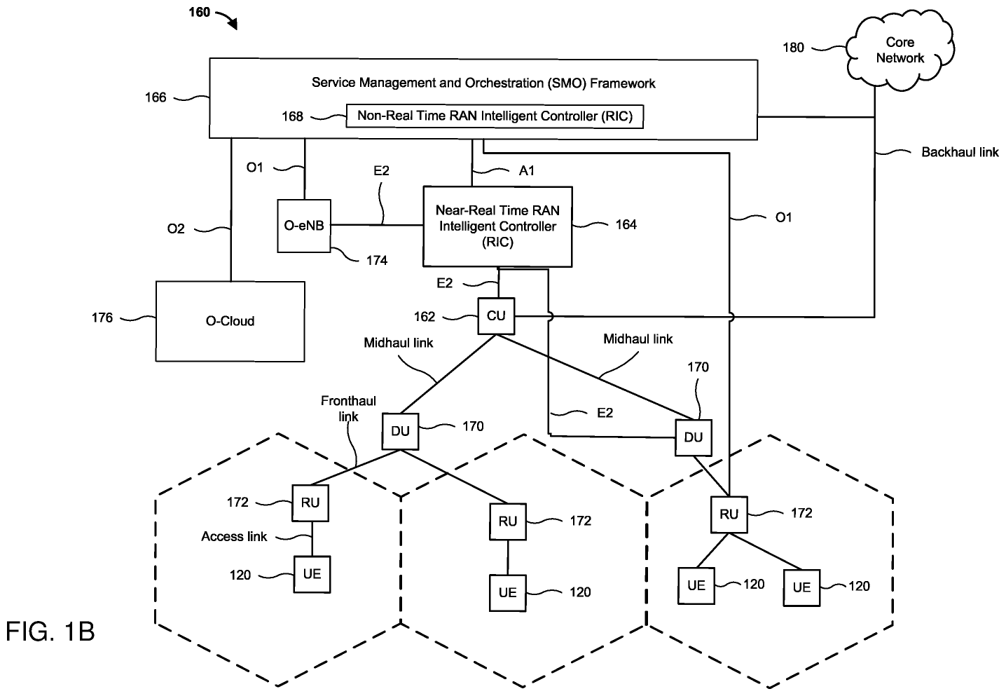

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as user equipment (UE) 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type of core network, such as an LTE core network (e.g., an EPC network), 5G core network, etc.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network.

NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices 120a-120e (for example, illustrated as the wireless device 120a and the wireless device 120e) may communicate directly using one or more sidelink channels 124 (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links.

The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a virtual RAN (vRAN) architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

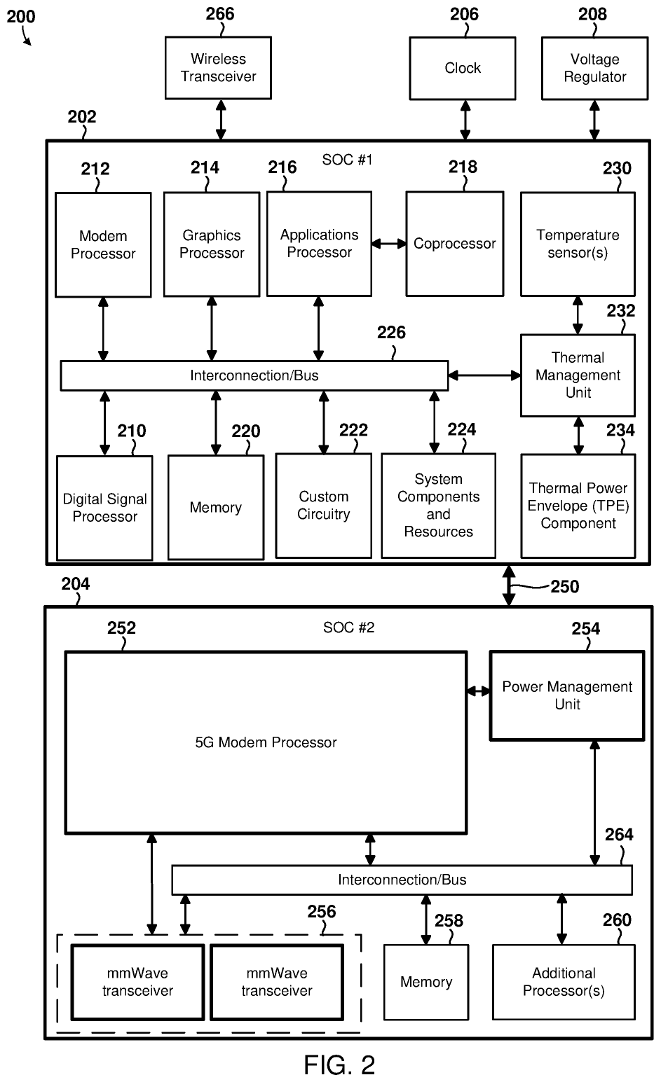

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing device 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

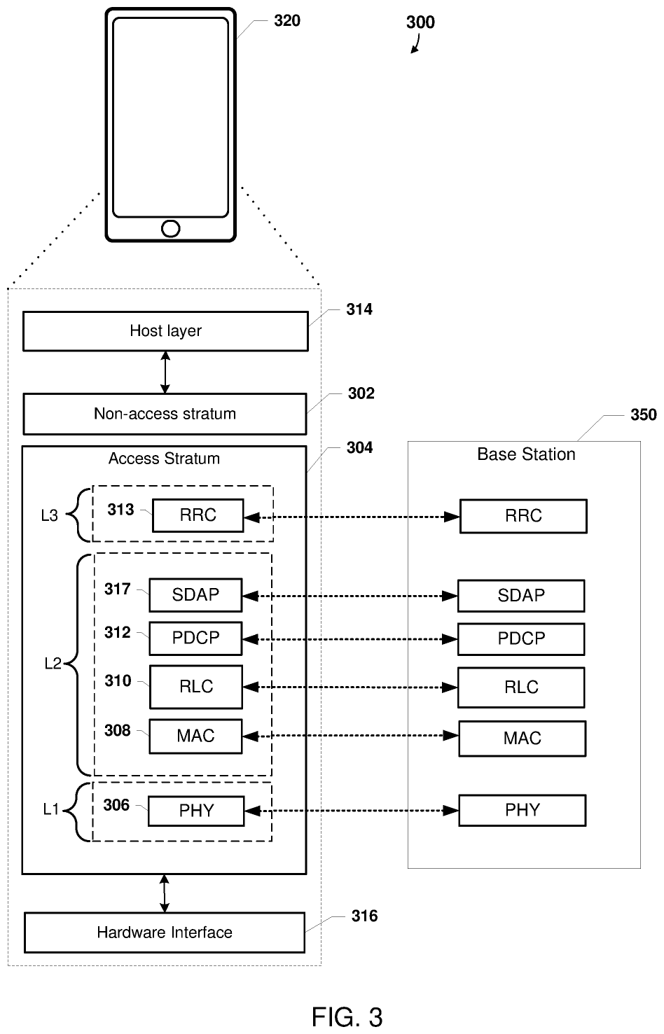

FIG. 3 is a component block diagram illustrating a software architecture 300 including a radio protocol stack for the user and control planes in wireless communications suitable for implementing any of the various embodiments. With reference to FIGS. 1A-3, the wireless device 320 may implement the software architecture 300 to facilitate communication between a wireless device 320 (e.g., the wireless device 120a-120e, 200) and the base station 350 (e.g., the base station 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the wireless device 320 and the base station 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

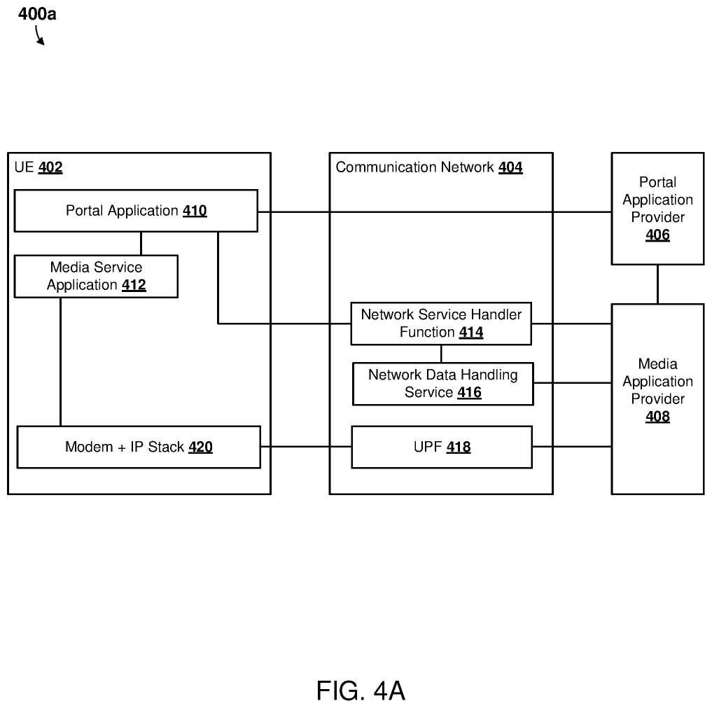

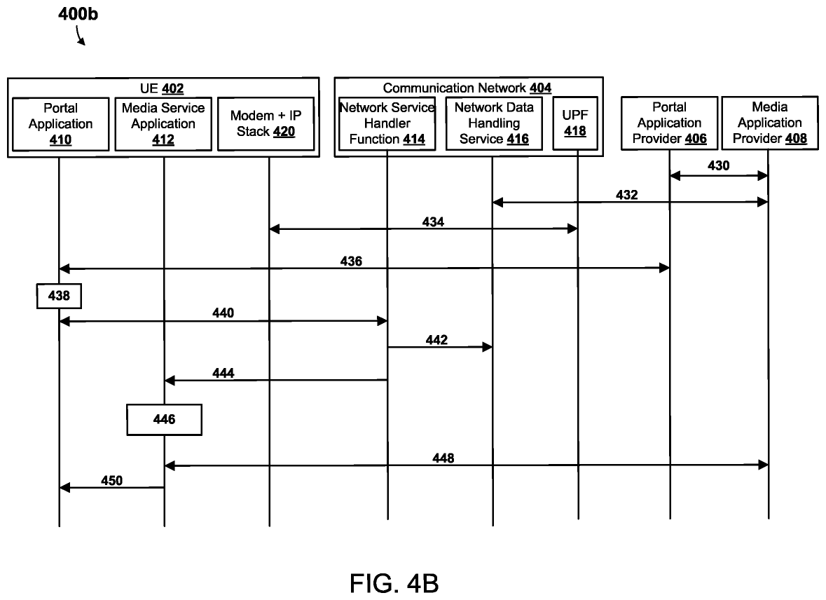

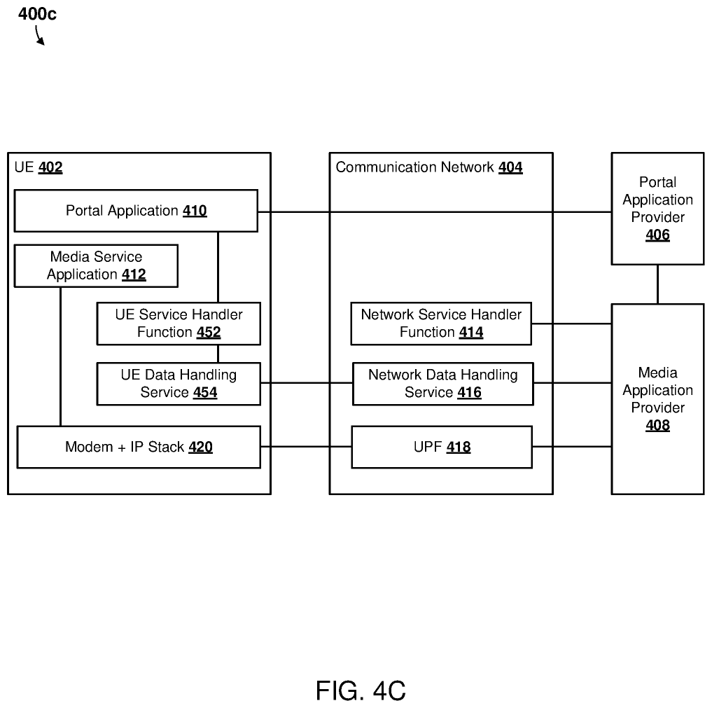

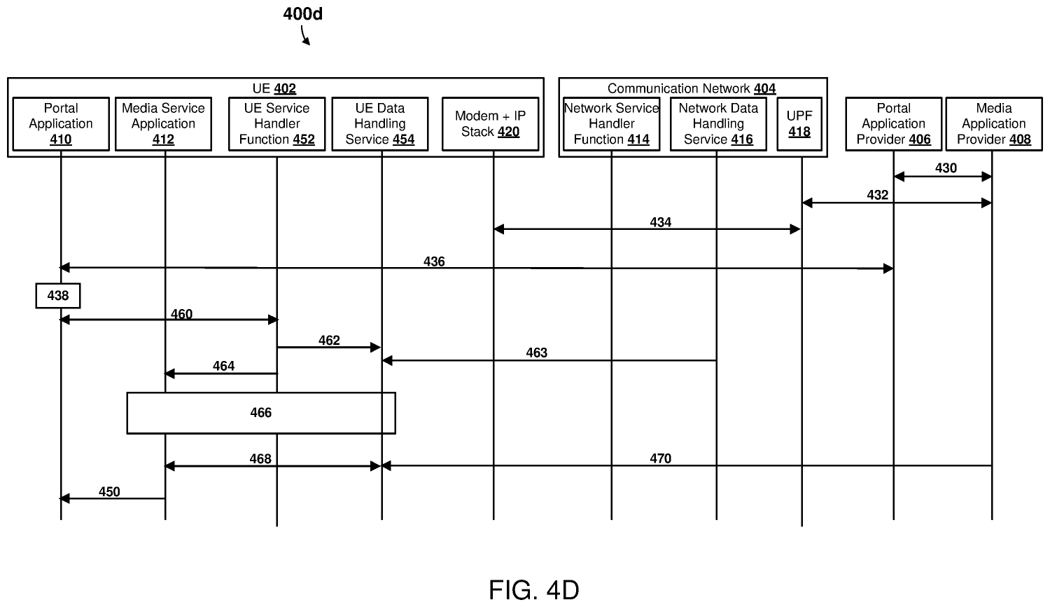

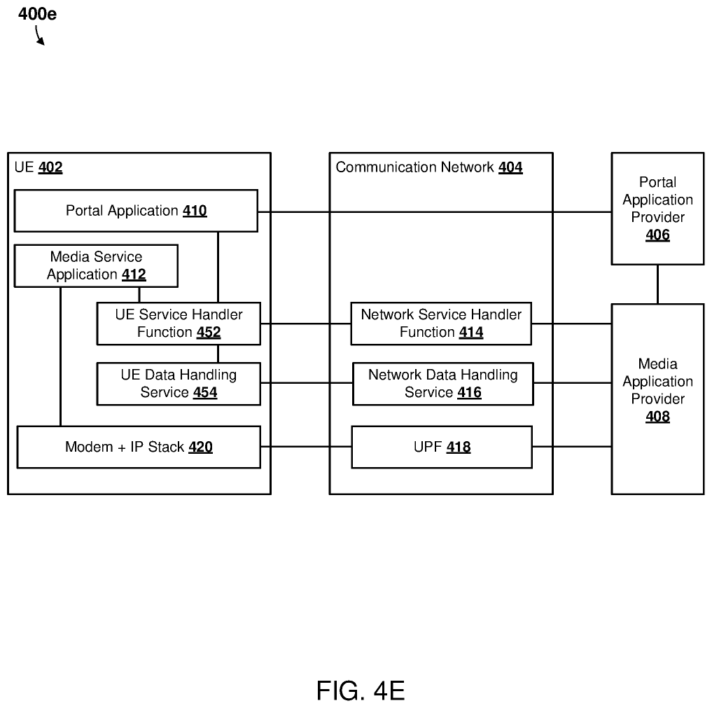

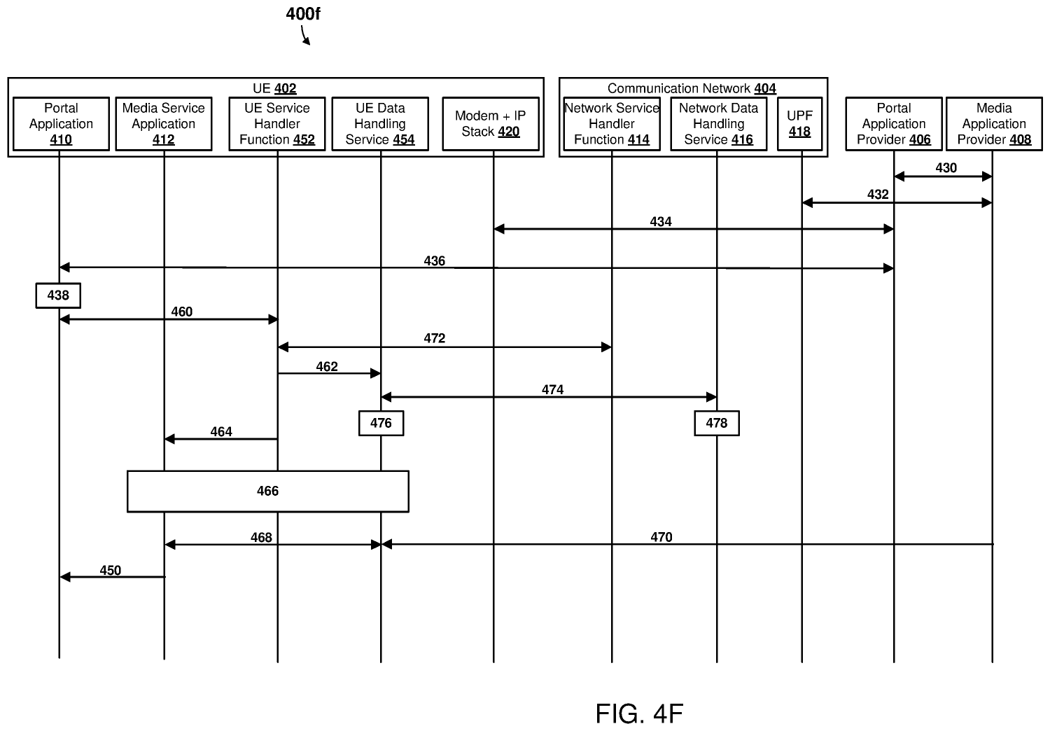

FIG. 4A is a component block diagram illustrating a system 400a configured to perform operations for configuring network services to support an application according to various embodiments. FIG. 4B is a message flow diagram illustrating a method 400b for configuring network services to support an application according to various embodiments. With reference to FIGS. 1-4B, the system 400a may include a UE 402 (e.g., 110a-110d, 200, 320), a communication network (e.g., 140), a portal application provider 406, and a media application provider 408. In various embodiments, the portal application provider 406 and the media application provider 408 may execute or be instantiated in one or more network elements that communicate with the communication network 404. In various embodiments, the communication network 404 may include one or more network elements as a part of the communication network 404. In some embodiments, a uniform resource locator (URL) associated with a data handling service 416 that supports an application operation of the application of the UE may be configured to be resolved by a function of a network element of the communication network.

In some embodiments, the media application provider 408 and the portal application provider 406 may perform operations 430 to communicate to generate and provide a media service entry point (e.g., an entry point URL). In operations 432, the media application provider 408 and a network data handling service 416 may perform operations 432 to provision a data handling service for one or more applications provided by or supported by the media application provider 408.

The UE 402 and a User Plane Function (UPF) 418 of the communication network 404 may perform operations 434 to establish a communication link (e.g., a best effort IP communication link). In some embodiments, the UE 402 may execute a portal application 410. The portal application 410 may include an application that will communicate with a network element such as the portal application provider 406 and/or the media application provider 408 to perform an application operation. In some embodiments, the portal application 410 and the portal application provider 406 may perform operations 436 by which the portal application provider 406 may provide an indication (e.g., a list or another suitable data structure) of media services and 3GPP media service entry point URLs to the portal application 410.

In operation 438, the UE 402 may receive an input (e.g., from a user, via an input device of the UE 402) selecting a media service via the portal application 410. In response to receiving the input selecting the media service, the portal application 410 may communicate with a network service handler function 414 of the communication network 404 to perform operations 440 to request a media service entry point URL for the selected media service. As part of the operations 440, the portal application 410 may send to the network service handler function 414 a service request including a URL associated with a data handling service that supports an operation of the portal application (an application operation).

The network service handler function 414 may resolve the URL to which the service request is directed. The network service handler function 414 and the network data handling service 416 may perform operations 442 to activate (initiate, launch) aspects or functions of the network data handling service 416. The network service handler function 414 also may send a redirect message 444 to a media service application 412 in the UE. In response to the received redirection message, the UE may perform operations 446 to execute the media service application 412. In some embodiments, the UE 402 may activate or launch the media service application 412 automatically based on the URL associated with the data handling service.

The media service application 412 and the media application provider 408 may perform operations 448 to obtain media content from the media application provider 408. Using the received communications (i.e., the media content), the media service application 412 may perform operations 450 to support the application operation of the portal application 410.

FIG. 4C is a component block diagram illustrating a system 400c configured to perform operations for configuring network services to support an application according to various embodiments. FIG. 4D is a message flow diagram illustrating a method 400d for configuring network services to support an application according to various embodiments. With reference to FIGS. 1-4D, the system 400c may include the UE 402 (e.g., 110a-110d, 200, 320), the communication network (e.g., 140), the portal application provider 406, and the media application provider 408. In various embodiments, the portal application provider 406 and the media application provider 408 may execute or be instantiated in one or more network elements that communicate with the communication network 404. In various embodiments, the communication network 404 may include one or more network elements as a part of the communication network 404. In some embodiments, the URL may be configured for resolution by a UE service handler function 452 executing in the UE 402.

In some embodiments, elements of the UE 402, the communication network 404, the portal application provider 406, and the media application provider 408 may perform operations 430-438 substantially as described with regard to FIGS. 4A and 4B.

In response to receiving the input selecting the media service in operation 438, the portal application 410 may communicate with the network service handler function 452 of the UE to send to the UE service handler function 452 a service request 460 including a URL associated with a data handling service that supports an operation of the portal application (an application operation). The UE service handler function 452 may resolve the URL to which the service request is directed. The UE service handler function 452 may send a message 462 to activate (initiate, launch) aspects or functions of the UE data handling service 454. The UE service handler function 454 may receive one or more messages 463 that include service access parameters, which may include a media service entry point. The UE service handler function 452 also may send a message 464 to initiate operations to launch (execute, initiate) the media service application 412. In some embodiments, the UE 402 may activate or launch the media service application 412 automatically based on the URL associated with the data handling service.

The media application service 412 and the UE data handling service 454 may perform operations 466 to establish inter-process communication, to enable the UE data handling service 454 to provide communications received from the media application provider 408 to the media service application 412. The media service application 412 and of the UE data handling service 454 may perform operations 468 by which the media service application 412 sends a request to the UE data handling service 454 requesting content from the media application provider 408. The UE data handling service 454 and the media application provider 408 may perform operations 468 by which the UE data handling service 454 requests content from the media application provider 408, in response to which the media application provider 408 to transmits communications including the requested content for the portal application 410 to the UE data handling service 454 of the UE 402. The UE data handling service 454 may receive the communications including the requested content and may send the communications to the media service application 412. Using the received communications (i.e., the media content), the media service application 412 may perform operations 450 to support the application operation of the portal application 410 substantially as described.

FIG. 4E is a component block diagram illustrating a system 400e configured to perform operations for configuring network services to support an application according to various embodiments. FIG. 4F is a message flow diagram illustrating a method 400f for configuring network services to support an application according to various embodiments. With reference to FIGS. 1-4F, the system 400d may include the UE 402 (e.g., 110a-110d, 200, 320), the communication network (e.g., 140), the portal application provider 406, and the media application provider 408. In various embodiments, the portal application provider 406 and the media application provider 408 may execute or be instantiated in one or more network elements that communicate with the communication network 404. In various embodiments, the communication network 404 may include one or more network elements as a part of the communication network 404. In some embodiments, the URL may be configured for resolution by a UE service handler function 452 executing in the UE 402. In some embodiments, the URL may be configured for resolution by the UE service handler function 452 executing in the UE 402, and by the network service handler function 414 in the communication network 404.

In some embodiments, elements of the UE 402, the communication network 404, the portal application provider 406, and the media application provider 408 may perform operations 430-438 substantially as described with regard to FIGS. 4A and 4B.

In response to receiving the input selecting the media service in operation 438, the portal application 410 may communicate with the network service handler function 452 of the UE to send to the UE service handler function 452 a service request 460 including a URL associated with a data handling service that supports an operation of the portal application (an application operation). The UE service handler function 452 may resolve the URL to which the service request is directed.

The UE service handler function 452 and the network service handler function 414 may perform operations 472 to determine, generate, transmit, and/or exchange service parameters related to the data handling service. The UE service handler function 452 may send a message 462 to activate (initiate, launch) aspects or functions of the UE data handling service 454. The UE data handling service 454 and the network data handling service 416 may perform operations 474 to exchange service parameters of the data handling service. The UE data handling service 454 may perform operations 476 to configure the UE data handling service 454 according to the service parameters. The network data handling service 416 may perform operations 478 to configure the network data handling service 416 according to the service parameters.

The UE service handler function 452 may send a message 464 to initiate operations to launch (execute, initiate) the media service application 412. In some embodiments, the UE 402 may activate or launch the media service application 412 automatically based on the URL associated with the data handling service.

The media application service 412, the UE data handling service 454, and the media application provider 408 may perform operations 468, 470, and 450 substantially as described with regard to FIGS. 4C and 4D.

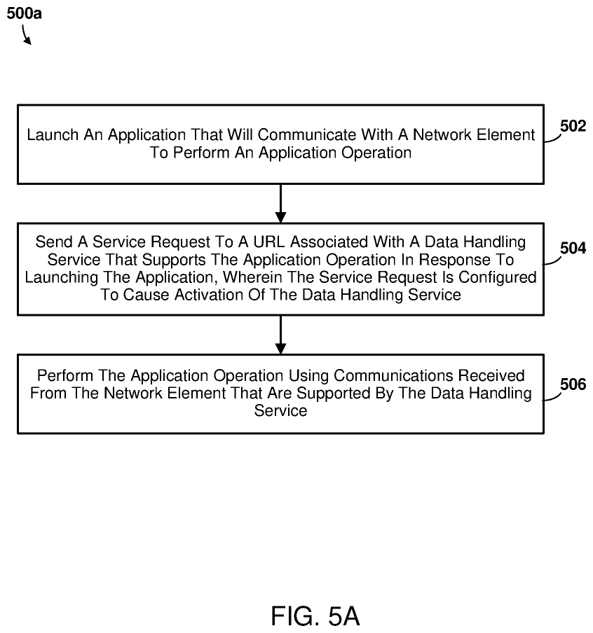

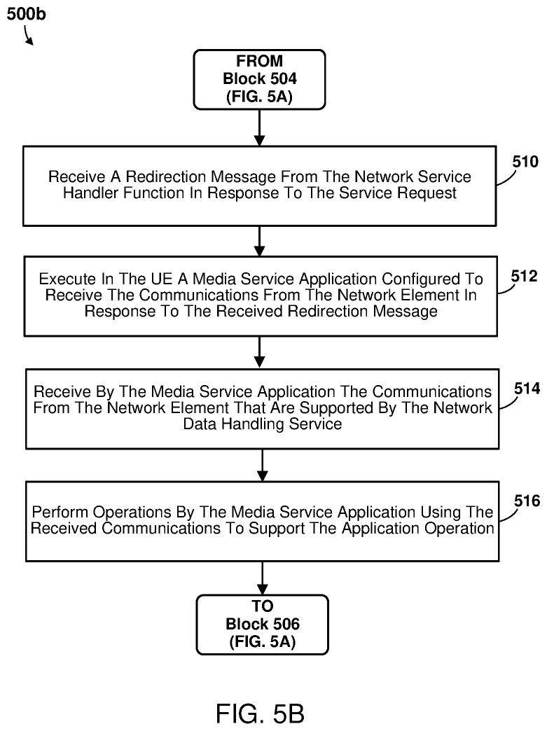

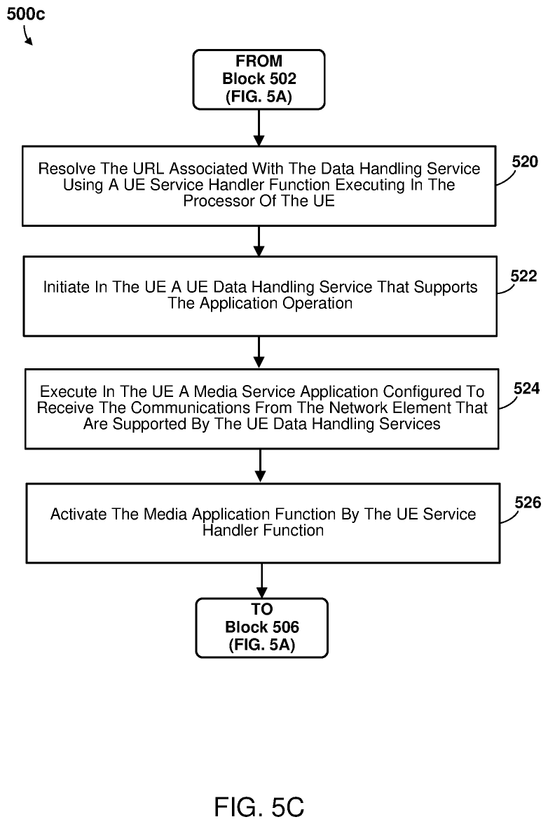

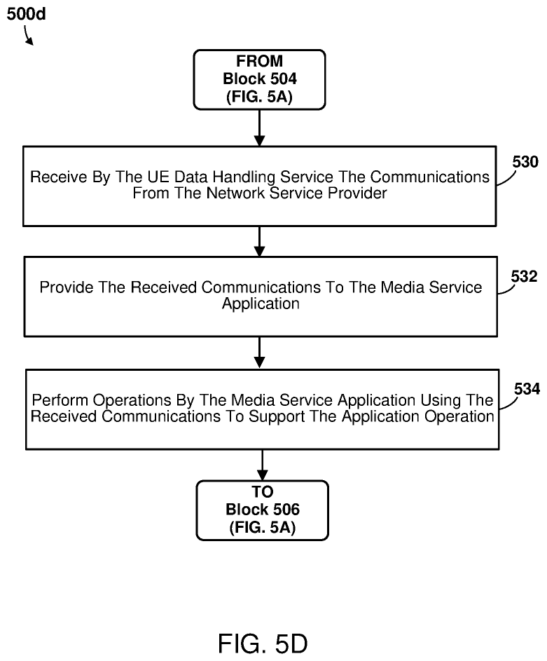

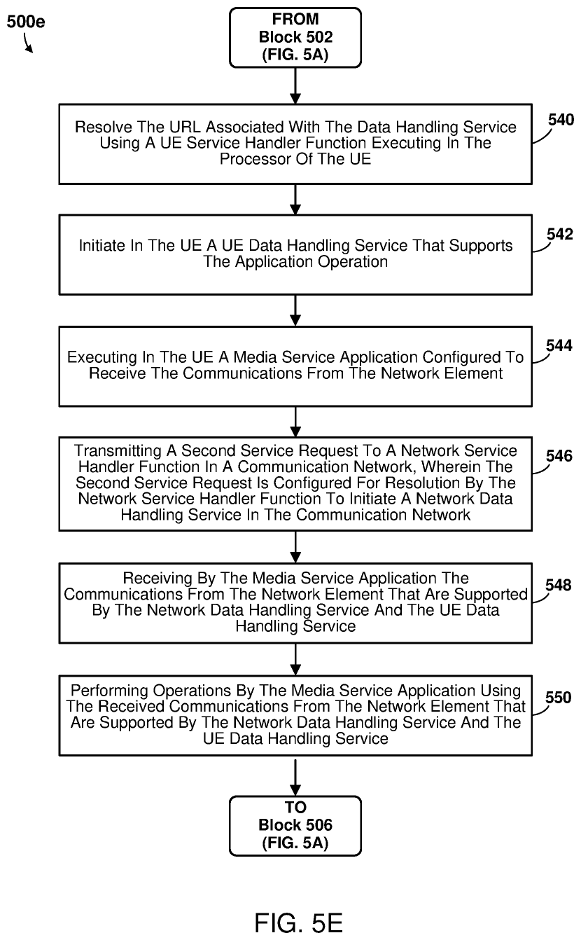

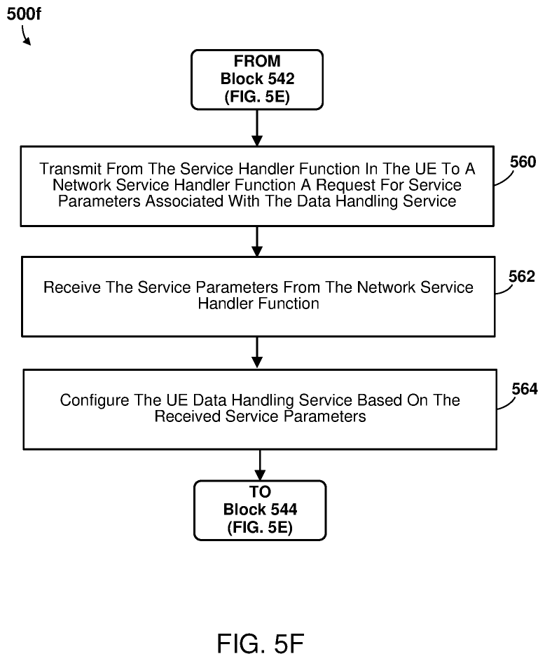

FIG. 5A is a process flow diagram illustrating a method 500a performed by a processor of a UE for configuring network services to support an application according to various embodiments. With reference to FIGS. 1A-5A, the operations of the method 500 may be performed by a processor (such as the processor 210, 212, 214, 216, 218, 252, 260, 428) of a UE (e.g., 110a-110d, 200, 320, 800).

In block 502, the processor may launch an application that will communicate with a network element to perform an application operation. For example, the UE may obtain (receive, request, be provided) an HTTP URL that is configured so as to be associated with a data service and a network data handling service.

In block 504, the processor may send a service request to a URL associated with a data handling service that supports the application operation in response to launching the application, wherein the service request is configured to cause activation of the data handling service. In some embodiments, the UE may send the service request to the URL in response to launching the application automatically, i.e., without a further user input. Sending the service request automatically may improve the user experience by reducing the number of user inputs required to launch an application and enabling the processor to begin receiving data services promptly after a single user action launching the application. In some embodiments, the processor may transmit the service request to a URL of a network service handler function in a communication network. In such embodiments, the service request may be configured to be resolved by the network service handler function to initiate a network data handling service in the communication network. For example, the UE may issue (transmit, transmit a message including) a request (e.g., a service request) to the URL on the UE. In response to the request issued by the UE, a data handling service may be launched in the UE (a UE data handling service), or in a network element of the communication network (a network data handling service), or in both the UE and in the network element. In some embodiments, the UE also may automatically launch (execute, initiate, start) an application configured to handle communications of the data service received from and/or transmitted to the communication network, in which such communications are supported by the data handling service of the UE and/or the network.

In block 506, the processor may perform the application operation using communications received from the network element that are supported by the data handling service.

FIGS. 5B-5F are process flow diagrams illustrating operations 500b-500f that may be performed by a processor of a UE as part of the method 500a for configuring network services to support an application according to various embodiments. With reference to FIGS. 1A-5F, the operations 500b-500f may be performed by a processor (such as the processor 210, 212, 214, 216, 218, 252, 260, 428) of a UE (e.g., 110a-110d, 200, 320, 800).

Referring to FIG. 5B, after sending a service request to a URL associated with a data handling service that supports the application operation in response to launching the application in block 504 as described, the processor may receive a redirection message from the network service handler function in response to the service request in block 510.

In block 512, the processor may execute in the UE a media service application configured to receive the communications from the network element in response to the received redirection message.

In block 514, the processor may receive by the media service application the communications from the network element that are supported by the network data handling service.

In block 516, the processor may perform operations by the media service application using the received communications to support the application operation.

The processor may perform the application operation using communications received from the network element that are supported by the data handling service in block 506, as described.

Referring to FIG. 5C, after launching an application that will communicate with a network element to perform an application operation in block 502 as described, the processor may resolve the URL associated with the data handling service using a UE service handler function executing in the processor of the UE in block 520.

In block 522, the processor may initiate in the UE a UE data handling service that supports the application operation.

In block 524, the processor may execute in the UE a media service application configured to receive the communications from the network element that are supported by the UE data handling services.

In block 526, the processor may activate the media application function by the UE service handler function.

The processor may perform the application operation using communications received from the network element that are supported by the data handling service in block 506, as described.

Referring to FIG. 5D, after sending a service request to a URL associated with a data handling service that supports the application operation in response to launching the application in block 504 as described, the processor may receive by the UE data handling service the communications from the network service provider in block 530.

In block 532, the processor may provide the received communications to the media service application.

In block 534, the processor may perform operations by the media service application using the received communications to support the application operation.

The processor may perform the application operation using communications received from the network element that are supported by the data handling service in block 506, as described.

Referring to FIG. 5E, after launching an application that will communicate with a network element to perform an application operation in block 502 as described, the processor may resolve the URL associated with the data handling service using a UE service handler function executing in the processor of the UE in block 540.

In block 542, the processor may initiate in the UE a UE data handling service that supports the application operation.

In block 544, the processor may execute in the UE a media service application configured to receive the communications from the network element.

In block 546, the processor may transmit a second service request to a network service handler function in a communication network. In some embodiments, the second service request may be configured for resolution by the network service handler function to initiate a network data handling service in the communication network.

In block 548, the processor may receive by the media service application the communications from the network element that are supported by the network data handling service and the UE data handling service.

In block 550, the processor may perform operations by the media service application using the received communications from the network element that are supported by the network data handling service and the UE data handling service.

Referring to FIG. 5F, after initiating in the UE a UE data handling service that supports the application operation in block 542 as described, the processor may transmit from the service handler function in the UE to a network service handler function a request for service parameters associated with the data handling service in block 560.

In block 562, the processor may receive the service parameters from the network service handler function.

In block 564, the processor may configure the UE data handling service based on the received service parameters.

The processor may execute in the UE a media service application configured to receive the communications from the network element in block 544, as described.

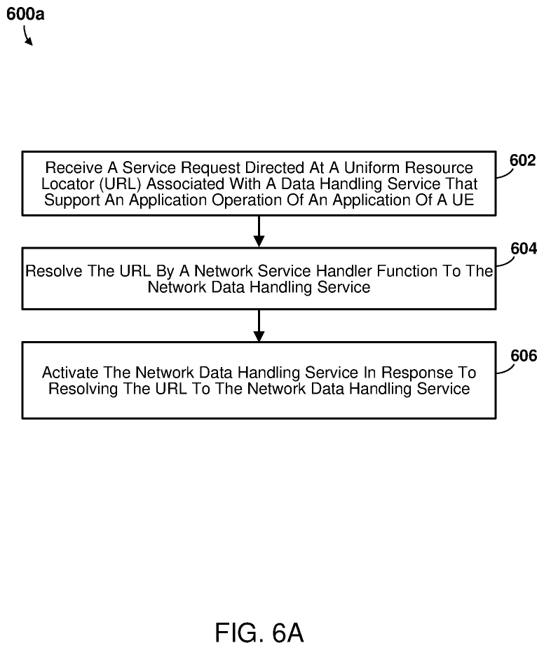

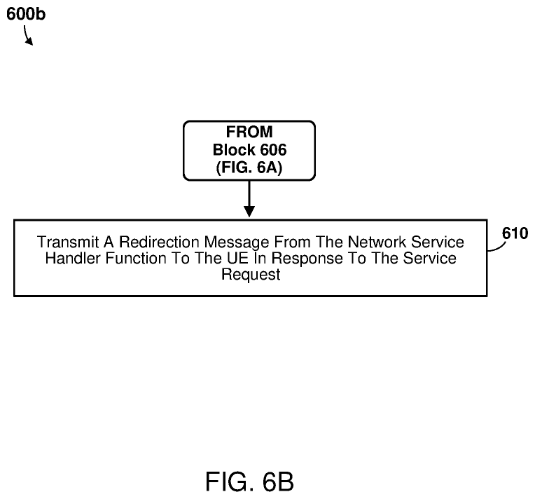

FIG. 6A is a process flow diagram illustrating a method 600a performed by a processor of a network element for configuring network services to support an application according to various embodiments. With reference to FIGS. 1A-6A, the operations of the method 600a may be performed by a processor (such as the processor 210, 212, 214, 216, 218, 252, 260, 428) of a network element (e.g., 414, 416, 418, 700).

In block 602, the processor may receive a service request directed at a uniform resource locator (URL) associated with a data handling service that support an application operation of an application of a user equipment (UE).

In block 604, the processor may resolve the URL by a network service handler function to the network data handling service.

In block 606, the processor may activate the network data handling service in response to resolving the URL to the network data handling service.

FIG. 6B is a process flow diagram illustrating operations 600b that may be performed by a processor of a network element as part of the method 600a for configuring network services to support an application according to various embodiments. With reference to FIGS. 1A-6B, the operations 600b may be performed by a processor (such as the processor 210, 212, 214, 216, 218, 252, 260, 428) of a network element (e.g., 414, 416, 418, 700).

After activating activate the network data handling service in response to resolving the URL to the network data handling service in block 606 as described, the processor may transmit a redirection message from the network service handler function to the UE in response to the service request in block 610. In some embodiments, the redirection message may be configured to trigger in the UE a media service application configured to support the application operation of the application of the UE.

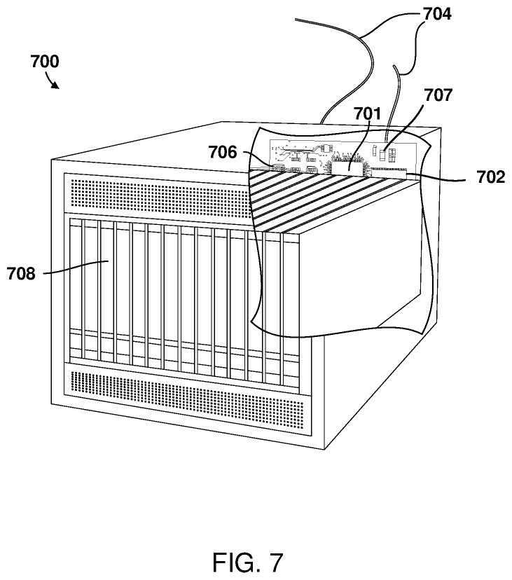

FIG. 7 is a component block diagram of a network element device suitable for use with various embodiments. With reference to FIGS. 1A-7, network element devices may implement functions (e.g., 414, 416, 418) in a communication network (e.g., 100, 150) and may include at least the components illustrated in FIG. 7. The network element device 700 may include a processor 701 coupled to volatile memory 702 and a large capacity nonvolatile memory, such as a disk drive 708. The network element device 700 also may include a peripheral memory access device 706 such as a floppy disc drive, compact disc (CD) or digital video disc (DVD) drive coupled to the processor 701. The network element device 700 also may include network access ports 704 (or interfaces) coupled to the processor 701 for establishing data connections with a network, such as the Internet or a local area network coupled to other system computers and servers. The network element device 700 may include one or more antennas 707 for sending and receiving electromagnetic radiation that may be connected to a wireless communication link. The network element device 700 may include additional access ports, such as USB, Firewire, Thunderbolt, and the like for coupling to peripherals, external memory, or other devices.

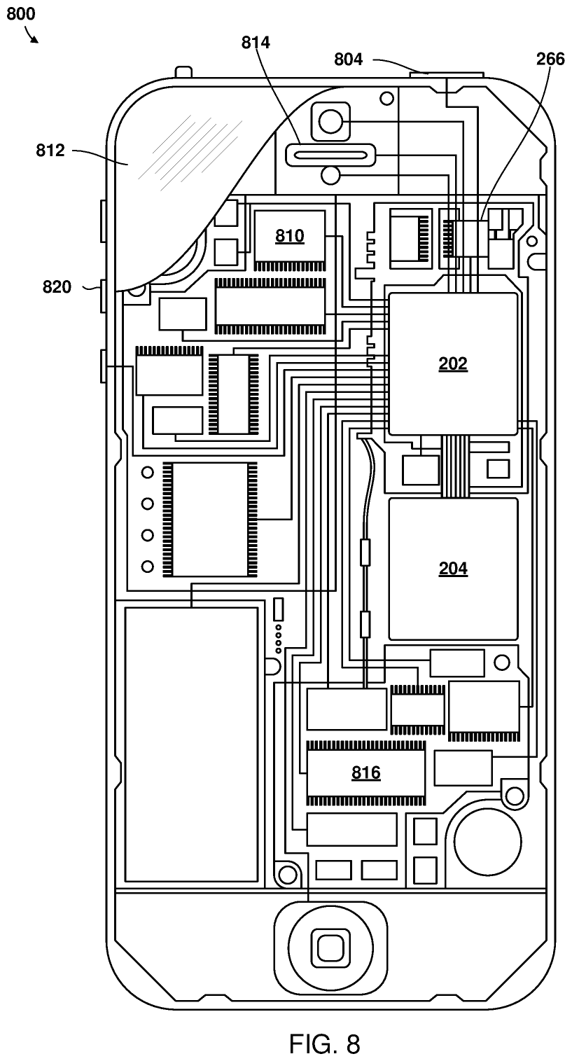

FIG. 8 is a component block diagram of a wireless device 800 suitable for use with various embodiments. In some embodiments, the wireless device 800 may operate as a network element. With reference to FIGS. 1A-8, various embodiments may be implemented on a variety of wireless devices 800 (for example, the wireless device 120a-120e, 200, 320, 404), an example of which is illustrated in FIG. 8 in the form of a smartphone. The wireless device 800 may include a first SOC 202 (for example, a SOC-CPU) coupled to a second SOC 204 (for example, a 5G capable SOC). The first and second SOCs 202, 204 may be coupled to internal memory 816, a display 812, and to a speaker 814. Additionally, the wireless device 800 may include an antenna 804 for sending and receiving electromagnetic radiation that may be connected to a transceiver 427 coupled to one or more processors in the first and/or second SOCs 202, 204. Wireless device 800 may include menu selection buttons or rocker switches 820 for receiving user inputs.

The wireless device 800 may include a sound encoding/decoding (CODEC) circuit 810, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 810 may include a digital signal processor (DSP) circuit (not shown separately).

The processors of the network element device 700 and the wireless device 800 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 702, 816 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 400b, 400d, 400f, 500a-500f, 600a, and 600b may be substituted for or combined with one or more operations of the methods and operations 400b, 400d, 400f, 500a-500f, 600a, and 600b.

Implementation examples are described in the following paragraphs. While some of the following implementation examples are described in terms of example methods, further example implementations may include: the example methods discussed in the following paragraphs implemented by a base station including a processor configured with processor-executable instructions to perform operations of the methods of the following implementation examples; the example methods discussed in the following paragraphs implemented by a base station including means for performing functions of the methods of the following implementation examples; and the example methods discussed in the following paragraphs may be implemented as a non-transitory processor-readable storage medium having stored thereon processor-executable instructions configured to cause a processor of a base station to perform the operations of the methods of the following implementation examples.

Example 1. A method performed by a processor of a user equipment (UE) for configuring network services to support an application, including launching an application that will communicate with a network element to perform an application operation, sending a service request to a uniform resource locator (URL) associated with a data handling service that supports the application operation in response to launching the application, in which the service request is configured to cause activation of the data handling service, and performing the application operation using communications received from the network element that are supported by the data handling service.

Example 2, the method of example 1, in which sending the service request to the URL associated with the data handling service that supports the application operation includes sending the service request to the URL automatically in response to launching the application (i.e., without a further user input).

Example 3. The method of either of examples 1 or 2, further including obtaining the URL from a communication network, in which the URL is associated with the data handling service and a data service provided by the network element.

Example 4. The method of any of claims 1-3, in which the activation of the data handling service occurs in the UE, in a communication network, or both.

Example 5. The method of any of claims 1-4, in which the application is a portal application that uses information received from a network element of a communication network

Example 6. The method of any of claims 1-5, in which the network element includes a network service provider.

Example 7. The method of any of examples 1-6, in which automatically sending the service request to the URL associated with the data handling service that supports the application operation includes transmitting the service request to a URL of a network service handler function in a communication network, in which the service request is configured to be resolved by the network service handler function to initiate a network data handling service in the communication network.

Example 8. The method of example 7, further including receiving a redirection message from the network service handler function in response to the service request, executing in the UE a media service application configured to receive the communications from the network element in response to the received redirection message, receiving by the media service application the communications from the network element that are supported by the network data handling service, and performing operations by the media service application using the received communications to support the application operation.

Example 9. The method of any of examples 1-8, in which automatically sending the service request to the URL associated with the data handling service that support the application operation includes resolving the URL associated with the data handling service using a UE service handler function executing in the processor of the UE, initiating in the UE a UE data handling service that supports the application operation, and executing in the UE a media service application configured to receive the communications from the network element that are supported by the UE data handling services.

Example 10. The method of example 9, in which performing the application operation using received communications that are supported by the data handling service includes receiving by the UE data handling service the communications from a network service provider, providing the received communications to the media service application, and performing operations by the media service application using the received communications to support the application operation.

Example 11. The method of example 59, further including activating the media application function by the UE service handler function.

Example 12. The method of any of examples 1-11, in which automatically sending the service request to the network URL associated with the data handling service that supports the application operation includes resolving the URL associated with the data handling service using a UE service handler function executing in the processor of the UE, initiating in the UE a UE data handling service that supports the application operation, executing in the UE a media service application configured to receive the communications from the network element, transmitting a second service request to a network service handler function in a communication network, in which the second service request is configured for resolution by the network service handler function to initiate a network data handling service in the communication network, and receiving by the media service application the communications from the network element that are supported by the network data handling service and the UE data handling service, in which performing the application operation using the received communications that are supported by the data handling service includes performing operations by the media service application using the received communications from the network element that are supported by the network data handling service and the UE data handling service.

Example 13. The method of example 12, further including transmitting from the UE service handler function to a network service handler function a request for service parameters associated with the data handling service, receiving the service parameters from the network service handler function, and configuring the UE data handling service based on the received service parameters.

Example 14. A method performed by a processor of a network element for configuring network services to support an application, including receiving a service request directed at a uniform resource locator (URL) associated with a data handling service that support an application operation of an application of a user equipment (UE), resolving by a network service handler function the URL to the network data handling service, and activating the network data handling service in response to resolving the URL to the network data handling service.

Example 15. The method of example 14, in which the application is a portal application.

Example 16. The method of either of examples 14 or 15, in which the network element is implemented as a part of a communication network.

Example 17. The method of any of examples 14-16, further including transmitting a redirection message from the network service handler function to the UE in response to the service request, in which the redirection message is configured to trigger in the UE a media service application configured to support the application operation of the application of the UE.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a user equipment (UE) for configuring network services to support an application, comprising:
launching an application that will communicate with a network element to perform an application operation;
sending a service request to a uniform resource locator (URL) associated with a data handling service that supports the application operation in response to launching the application, wherein the service request is configured to cause activation of the data handling service; and
performing the application operation using communications received from the network element that are supported by the data handling service.

2. The method of claim 1, wherein sending the service request to the URL associated with the data handling service that supports the application operation comprises sending the service request to the URL automatically in response to launching the application.

3. The method of claim 1, further comprising obtaining the URL from a communication network, wherein the URL is associated with the data handling service and a data service provided by the network element.

4. The method of claim 1, wherein the activation of the data handling service occurs in the UE, in a communication network, or both.

5. The method of claim 1, wherein the application is a portal application.

6. The method of claim 1, wherein the network element comprises a network service provider.

7. The method of claim 1, wherein automatically sending the service request to the URL associated with the data handling service that supports the application operation comprises transmitting the service request to a URL of a network service handler function in a communication network, wherein the service request is configured to be resolved by the network service handler function to initiate a network data handling service in the communication network.

8. The method of claim 7, further comprising:
receiving a redirection message from the network service handler function in response to the service request;
executing in the UE a media service application configured to receive the communications from the network element in response to the received redirection message;
receiving by the media service application the communications from the network element that are supported by the network data handling service; and
performing operations by the media service application using the received communications to support the application operation.

9. The method of claim 1, wherein automatically sending the service request to the URL associated with the data handling service that support the application operation comprises:
resolving the URL associated with the data handling service using a UE service handler function executing in the processor of the UE;
initiating in the UE a UE data handling service that supports the application operation; and
executing in the UE a media service application configured to receive the communications from the network element that are supported by the UE data handling services.

10. The method of claim 9, wherein performing the application operation using received communications that are supported by the data handling service comprises:
receiving by the UE data handling service the communications from a network service provider;
providing the received communications to the media service application; and
performing operations by the media service application using the received communications to support the application operation.

11. The method of claim 9, further comprising activating the media application function by the UE service handler function.

12. The method of claim 1, wherein automatically sending the service request to the network URL associated with the data handling service that supports the application operation comprises:
resolving the URL associated with the data handling service using a UE service handler function executing in the processor of the UE;
initiating in the UE a UE data handling service that supports the application operation;
executing in the UE a media service application configured to receive the communications from the network element;
transmitting a second service request to a network service handler function in a communication network, wherein the second service request is configured for resolution by the network service handler function to initiate a network data handling service in the communication network; and
receiving by the media service application the communications from the network element that are supported by the network data handling service and the UE data handling service,
wherein performing the application operation using the received communications that are supported by the data handling service comprises performing operations by the media service application using the received communications from the network element that are supported by the network data handling service and the UE data handling service.

13. The method of claim 12, further comprising:
transmitting from the UE service handler function to a network service handler function a request for service parameters associated with the data handling service;
receiving the service parameters from the network service handler function; and
configuring the UE data handling service based on the received service parameters.

14. A user equipment (UE), comprising:
a processor configured to:
launch an application that will communicate with a network element to perform an application operation;
send a service request to a uniform resource locator (URL) associated with a data handling service that supports the application operation in response to launching the application, wherein the service request is configured to cause activation of the data handling service; and
perform the application operation using communications received from the network element that are supported by the data handling service.

15. The UE of claim 14, wherein the processor is further configured to send the service request to the URL associated with the data handling service that supports the application automatically in response to launching the application.

16. The UE of claim 14, wherein the processor is further configured to obtain the URL from a communication network, wherein the URL is associated with the data handling service and a data service provided by the network element.

17. The UE of claim 14, wherein the processor is further configured to transmit the service request to a URL of a network service handler function in a communication network, wherein the service request is configured to be resolved by the network service handler function to initiate a network data handling service in the communication network.

18. The UE of claim 17, wherein the processor is further configured to:
receive a redirection message from the network service handler function in response to the service request;
execute in the UE a media service application configured to receive the communications from the network element in response to the received redirection message;
receive by the media service application the communications from the network element that are supported by the network data handling service; and
perform operations by the media service application using the received communications to support the application operation.

19. The UE of claim 14, wherein the processor is further configured to:
resolve the URL associated with the data handling service using a UE service handler function executing in the processor of the UE;
initiate in the UE a UE data handling service that supports the application operation; and
execute in the UE a media service application configured to receive the communications from the network element that are supported by the UE data handling services.

20. The UE of claim 19, wherein the processor is further configured to:
receive by the UE data handling service the communications from a network service provider;
provide the received communications to the media service application; and
perform operations by the media service application using the received communications to support the application operation.

21. The UE of claim 19, wherein the processor is further configured to activate the media application function by the UE service handler function.

22. The UE of claim 14, wherein the processor is further configured to:
resolve the URL associated with the data handling service using a UE service handler function executing in the processor of the UE;
initiate in the UE a UE data handling service that supports the application operation;
execute in the UE a media service application configured to receive the communications from the network element;
transmit a second service request to a network service handler function in a communication network, wherein the second service request is configured for resolution by the network service handler function to initiate a network data handling service in the communication network;
receive by the media service application the communications from the network element that are supported by the network data handling service and the UE data handling service; and
perform operations by the media service application using the received communications from the network element that are supported by the network data handling service and the UE data handling service.

23. The UE of claim 22, wherein the processor is further configured to:
transmit from the service handler function in the UE to a network service handler function a request for service parameters associated with the data handling service;
receive the service parameters from the network service handler function; and
configure the UE data handling service based on the received service parameters.

24. A user equipment (UE), comprising:
means for launching an application that will communicate with a network element to perform an application operation;
means for sending a service request to a uniform resource locator (URL) associated with a data handling service that supports the application operation in response to launching the application, wherein the service request is configured to cause activation of the data handling service; and
means for performing the application operation using communications received from the network element that are supported by the data handling service.

25. The UE of claim 24, wherein means for sending the service request to the URL associated with the data handling service that supports the application operation in response to launching the application comprises means for automatically sending the service request to the URL associated with the data handling service that supports the application operation in response to launching the application.

26. A non-transitory processor-readable medium having stored thereon processor-executable instructions configured to cause a processing device in a user equipment (UE) to perform operations comprising:
launching an application that will communicate with a network element to perform an application operation;
sending a service request to a uniform resource locator (URL) associated with a data handling service that supports the application operation in response to launching the application, wherein the service request is configured to cause activation of the data handling service; and
performing the application operation using communications received from the network element that are supported by the data handling service.

27. A method performed by a processor of a network element for configuring network services to support an application, comprising:
receiving a service request directed at a uniform resource locator (URL) associated with a data handling service that support an application operation of an application of a user equipment (UE);
resolving by a network service handler function the URL to the network data handling service; and
activating the network data handling service in response to resolving the URL to the network data handling service.

28. The method of claim 27, wherein the application is a portal application.

29. The method of claim 27, wherein the network element is implemented as a part of a communication network.

30. The method of claim 27, further comprising:
transmitting a redirection message from the network service handler function to the UE in response to the service request, wherein the redirection message is configured to trigger in the UE a media service application configured to support the application operation of the application of the UE.

31. A network element, comprising:
a processor configured with processor-executable instructions to:
receive a service request directed at a uniform resource locator (URL) associated with a data handling service that support an application operation of an application of a user equipment (UE);
resolve by a network service handler function the URL to the network data handling service; and
activate the network data handling service in response to resolving the URL to the network data handling service.

32. The network element of claim 31, wherein the processor is further configured with processor-executable instructions to transmit a redirection message from the network service handler function to the UE in response to the service request, wherein the redirection message is configured to trigger in the UE a media service application configured to support the application operation of the application of the UE.

33. A network element, comprising:
means for receiving a service request directed at a uniform resource locator (URL) associated with a data handling service that support an application operation of an application of a user equipment (UE);
means for resolving by a network service handler function the URL to the network data handling service; and
means for activating the network data handling service in response to resolving the URL to the network data handling service.

34. A non-transitory processor-readable medium having stored thereon processor-executable instructions configured to cause a processing device in a network element to perform operations comprising:
receiving a service request directed at a uniform resource locator (URL) associated with a data handling service that support an application operation of an application of a user equipment (UE);
resolving by a network service handler function the URL to the network data handling service; and
activating the network data handling service in response to resolving the URL to the network data handling service.
